(19) United States
(12) Patent Application Publication
(10) Pub. No.: US 2017/0192979 A1
(43) Pub. Date: Jul. 6, 2017

(54) METHODS AND APPARATUSES FOR ACCESSING CLOUD STORAGE SERVICE BY USING TRADITIONAL FILE SYSTEM INTERFACE

(71) Applicant: ALIBABA GROUP HOLDING LIMITED, George Town (KY)

(72) Inventor: Yehui YANG, Hangzhou (CN)

(73) Assignee: ALIBABA GROUP HOLDING LIMITED

(21) Appl. No.: 15/393,568

(22) Filed: Dec. 29, 2016

(30) Foreign Application Priority Data
Dec. 30, 2015 (CN) 201511025311.4

(51) Int. Cl. G06F 17/30

(52) U.S. Cl. CPC G06F 17/30076; G06F 17/30165

(57) ABSTRACT

Methods and devices for accessing a cloud storage service based on a traditional file system interface. In one implementation, the method may include acquiring a traditional file access request sent by a client application; determining whether the traditional file access request is related to a cloud storage service system based on pre-stored file or disk information related to the cloud storage service system; responsive to determining that the traditional file access request is related to a cloud storage service system, converting the traditional file access request into an access request recognizable by the cloud storage service system and initiating an access to the cloud storage service system; and receiving result data returned by the cloud storage service system, converting the result data into a traditional file format, and returning the result data to the client application.

### CROSS-REFERENCE TO RELATED APPLICATION

This application claims priority to and benefits of Chinese Patent Application Serial No. 201511025311.4, filed with the State Intellectual Property Office of P. R. China on Dec. 30, 2015, which is incorporated herein by reference in its entirety.

### TECHNICAL FIELD

The present disclosure relates to the field of computer technologies, and more particularly to methods and apparatuses for accessing a cloud storage service based on a traditional file system interface.

### BACKGROUND

Computers manage and store data by using file systems. In the era of information explosion, the amount of data that can be acquired by people increases exponentially. The storage capacity of traditional file systems is expanded simply by increasing the number of hard disks, which is not satisfactory for meeting the current need of data and file storage and management in many aspects, such as the size and growth rate of the storage capacity, data backup, and data security. Accordingly, a distributed file system and/or an object storage system supporting cloud storage services emerged as viable options as both types of systems can effectively address some of the problems in data storage and management of file systems.

For example, a distributed file system can extend a file system fixed in a particular place to any combination of multiple places and multiple file systems, and can include numerous nodes of a file system network. Each node may be distributed at a different place, and communication and data transmission can be performed among the nodes through the network. People who use the distributed file system do not need to know the node on which data is stored or the node from which data is acquired, but can simply manage and store data in the distributed file system as if they were using a local file system.

An object storage system can be an object/file-oriented Internet massive storage system, which sometimes may also be referred to as cloud storage. Similar to the distributed file system, the capacity of the object storage system can also be expanded by increasing the number of storage nodes. Users also can simply manage and store data in the object storage system as if they were using a local file system.

Compared with traditional file systems, the distributed file system and the object storage system have the advantages of unlimited capacity expansion and high data reliability, along with allowing for massive parallel data access. But to use both the distributed file system and the object storage system generally requires a particular access interface or application programming interface (API). As a result, if the interface of existing software is not changed, the software cannot directly access the distributed file system and/or the object storage system.

### SUMMARY

To solve the above technical problems, embodiments of the present disclosure provide methods and apparatuses for accessing a cloud storage service based on a traditional file system interface.

In some embodiments, the present disclosure provides a method for accessing a cloud storage service by using a conventional file system interface. The method may include acquiring a traditional file access request sent by a client application; determining whether the traditional file access request is related to a cloud storage service system based on pre-stored file or disk information related to the cloud storage service system; responsive to determining that the traditional file access request is related to a cloud storage service, converting the traditional file access request into an access request recognizable by the cloud storage service system and initiating an access to the cloud storage service system; and receiving result data returned by the cloud storage service system, converting the result data into a traditional file format, and returning the result data to the client application.

In some embodiments, the present disclosure provides an apparatus for accessing a cloud storage service based on a traditional file system interface. The apparatus may include an acquiring unit that acquires a traditional file access request sent by a client application; a determining unit that determines whether the traditional file access request is related to a cloud storage service system based on pre-stored file or disk information related to the cloud storage service system; and responsive to determining that the traditional file access request is related to a cloud storage service system, executes a conversion unit; the conversion unit that converts the traditional file access request into an access request recognizable by the cloud storage service system and initiates an access to the cloud storage service system; and a feedback unit that receives result data returned by the cloud storage service system, converts the result data into a traditional file format, and returns the result data to the client application.

In some embodiments, the present disclosure provides a non-transitory computer readable medium that stores a set of instructions that is executable by at least one processor of a server to cause the server to perform a method for uploading a program based on a target network platform. The method may include the steps of: acquiring a traditional file access request sent by a client application; determining whether the traditional file access request is related to a cloud storage service system based on pre-stored file or disk information related to the cloud storage service system; responsive to determining that the traditional file access request is related to a cloud storage service system, converting the traditional file access request into an access request recognizable by the cloud storage service system and initiating an access to the cloud storage service system; and receiving result data returned by the cloud storage service system, converting the result data into a traditional file format, and returning the result data to the client application.

In accordance with the technical solutions provided by the present disclosure, modifications are not necessarily needed to be made to traditional software, and the traditional software may still initiate a traditional file access request by using an interface provided by a traditional operating system. For example, the traditional file access request may be acquired first. Then, it is determined whether the traditional file access request is related to a cloud storage service system based on pre-stored file or disk information correlated to the cloud storage service system. Responsive to determining that the traditional file access request is related to a cloud storage service system, the traditional file access request is converted into an access request recognizable by the cloud storage service system, and an access is initiated to the cloud storage service system. Additionally, resulting data returned by the cloud storage service system is received, converted into a traditional file format, and returned to the client application. In this way, in accordance with the present disclosure, the running logic of the traditional software is changed by converting the traditional file access request into an access request recognizable by the cloud storage service system without changing the interface of the traditional software, such that the cloud storage service system responds to the request, thereby providing a convenient method for the traditional software to access the cloud storage service system.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF DRAWINGS

The accompanying drawings constitute a part of this specification. The drawings illustrate several embodiments of the present disclosure and, together with the description, serve to explain the principles of the disclosure.

FIG. 1 is a schematic diagram illustrating an exemplary method for accessing a traditional file system by a traditional application program.

FIG. 2 is a schematic diagram illustrating an exemplary method for accessing a distributed file system by distributed software.

FIG. 3 is a flowchart of an exemplary method for accessing a cloud storage service based on a traditional file system interface, consistent with embodiments of the present disclosure.

FIG. 4 is a schematic diagram illustrating an exemplary method for accessing a cloud storage service based on a traditional file system interface, consistent with embodiments of the present disclosure.

FIG. 5 is a schematic diagram illustrating exemplary implementation of the method of FIG. 4, consistent with embodiments of the present disclosure.

FIG. 6 is a schematic block diagram illustrating an exemplary apparatus for accessing a cloud storage service based on a traditional file system interface, consistent with embodiments of the present disclosure.

### DETAILED DESCRIPTION

Reference will now be made in detail to embodiments and aspects of the present disclosure, examples of which are illustrated in the accompanying drawings. Where possible, the same reference numbers will be used throughout the drawings to refer to the same or like parts.

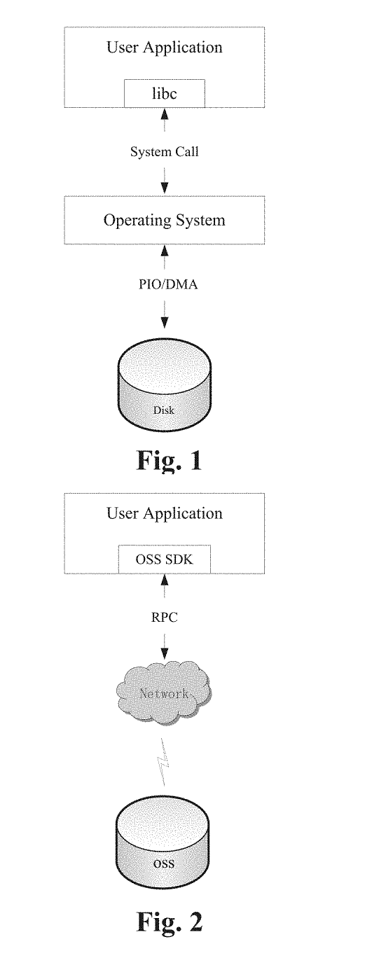

Traditional software, such as a traditional application program, accesses a file on a local disk by using a file system API. FIG. 1 is a schematic diagram illustrating an exemplary method for accessing a traditional file system by a traditional application program, which is herein referred to as a traditional application. For example, in a Linux system, a traditional application generally relies on libc (e.g., a library of standard functions that can be used by all C programs), and submits a traditional file access request to an operating system by using a file access interface defined by the Portable Operating System Interface (POSIX), using operations such as read( ) write( ) seek( ) or readdir( ). The operating system accesses and/or uses data stored on a local disk or network disk by using a corresponding file system module. As shown in FIG. 1, the operating system may perform the data access in two modes: programmed input/output (PIO) and/or direct memory access (DMA). FIG. 1 illustrates data accessing using the Linux system as an example. In a Windows™ system, traditional software accesses data on a local disk by directly using Win32API. For accessing a file by a traditional application, the difference between the Linux system and the Windows™ system lies in that different functions are called, but the principles of accessing the file are generally the same.

For later developed software, e.g., distributed software, that can directly access a cloud storage system, such as an Object Storage Service (OSS) application, the software is linked to a Software Development Kit (SDK) of the cloud storage system at the development stage, so that the cloud storage system can be directly accessed by using the SDK. FIG. 2 is a schematic diagram illustrating an exemplary method for accessing a distributed file system by distributed software. As shown in FIG. 2, the distributed software, e.g., an OSS application, is linked to an SDK through coding at the development stage, so that in use, data can be accessed through a network (e.g., OSS) by using the Remote Procedure Call (RPC) protocol through the SDK and the distributed file system (e.g., the cloud storage system).

Therefore, to allow traditional software to directly access a cloud storage system, program codes of the traditional software can be modified first to link the software to an SDK of a cloud storage service system. However, because the process of modifying the codes of the traditional software is more complicated than that of developing new software, programmers prefer developing new software to modifying the codes of the traditional software, resulting in that traditional software currently cannot directly access a cloud storage service system.

Therefore, the present disclosure provides a method and apparatus for accessing a cloud storage service based on a traditional file system interface. In accordance with the technical solution provided by the present disclosure, in a case where no modification is made to traditional software and the traditional software still initiates a traditional file access request by using an interface provided by a traditional operating system, the format of the traditional file access request is converted into an access request recognizable by a cloud storage service system, thereby implementing the access to the cloud storage service system. In this way, the running logic of the traditional software is changed by converting the format of the access request without changing the interface of the traditional software, thereby providing a convenient method for the traditional software to access the cloud storage service system.

Technical solutions and advantages of the present disclosure will be described below with reference to the accompanying drawings of the embodiments of the present disclosure. Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims. It is to be understood that both the foregoing general description and the following detailed description are examples and explanatory only and are not restrictive of the disclosed embodiments as claimed.

As described herein, the embodiments of the present disclosure can be applied to not only a Linux system, but also a Windows™ system, or any other suitable operating systems, with the same or similar principles of implementation consistent with the present disclosure. For purposes of simplicity, the following uses the Linux system as a non-limiting example for application of the embodiments of the present disclosure.

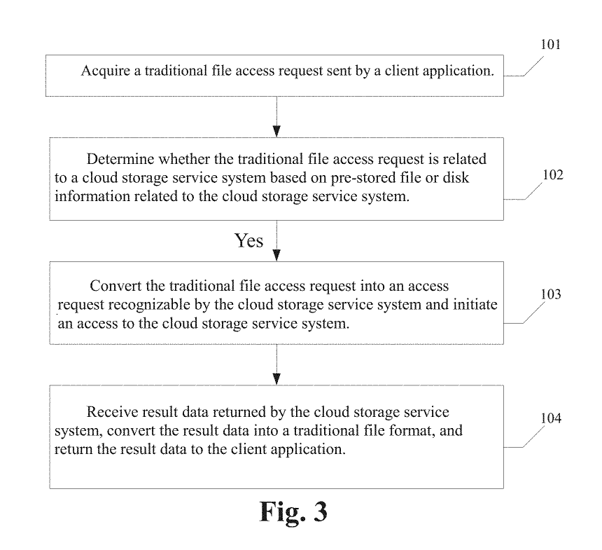

FIG. 3 is a flowchart of an exemplary method for accessing a cloud storage service based on a traditional file system interface, consistent with embodiments of the present disclosure. As shown in FIG. 3, the method may include: steps 101-104.

Step 101: Acquire a traditional file access request sent by a client application.

As used herein, the client application refers to a traditional application installed on a client. The traditional application may also be understood as traditional software, which refers to an application that is not linked to an SDK of a cloud storage service system, that cannot directly access the cloud storage service system, and that can only access a local disk or network disk by using a traditional file access request. For example, in a Linux system, a traditional file access request sent by a traditional application is converted by libc into a system call, and then submitted to the operating system. After the system call is trapped into the kernel, the operating system directly accesses a disk in accordance with the access request.

To implement the access of the traditional application to the cloud storage service system, the traditional file access request sent by the client application is acquired before the operating system performs an access in accordance with the traditional file access request.

In some embodiments, the traditional file access request sent by the client application may be acquired by using an API HOOK program. The API HOOK program may be understood as a Hanger or Hook. A Hook is placed on an API to intercept a traditional file access request by capturing an API call. In the embodiments of the present disclosure, API HOOK may be understood as a message processing program, which is mounted to the system via a system call. When a particular message associated with the Hook is sent, the Hook captures the message before the message reaches a destination window, which may be understood as the Hook function gaining control over the message. In such instances, the Hook function can process the message to change the message, or may continue to transmit the message without performing any processing on the message, or may forcibly end the transmission of the message. In the embodiments of the present disclosure, the traditional file access request is captured by using the API Hook technology.

In some embodiments, the traditional file access request sent by the client application may alternatively be acquired by the operating system. For example, the client application may be in a user running state (user mode) when running its own code, and may be in a kernel running state (kernel mode) when it executes a system call and the system call is trapped into kernel code. An application usually initially runs in user mode, and switches to the kernel mode via a system call when the application needs to use system resources. Therefore, when the client application sends a traditional file access request, it can be trapped into the kernel mode via a system call. In such instances, the operating system finds the traditional file access request, and then acquires the traditional file access request.

After step 101 is executed, step 102 is executed.

Step 102: Determine whether the traditional file access request is associated with a cloud storage service system based on pre-stored file or disk information related to the cloud storage service system.

The traditional file access request is used for accessing a file on a client disk. Upon receiving the traditional file access request, the operating system directly accesses the file on the client disk. However, in the embodiments of the present disclosure, the access operation is not executed directly. Instead, it is first determined whether the traditional file access request is used for accessing a cloud storage service system based on pre-stored file or disk information related to the cloud storage service system; if yes, perform step 103; otherwise, the file on the disk is accessed in a traditional manner.

In some embodiments, step 102 may have several implementation modes, which are explained and illustrated below in detail.

A first implementation mode of step 102 includes, for example: S11-S12:

S11: Extract, from the traditional file access request, a disk number of a disk to be accessed.

S12: Determine whether the disk number is present in a pre-stored mapping table of the relationship between disk numbers and the cloud storage service system, and if yes, ascertain that the traditional file access request is related to accessing the cloud storage service system.

In some embodiments, the pre-stored mapping table of the relationship between disk numbers and the cloud storage service system may include a one-to-one correspondence relationship between one group of disk numbers and the cloud storage service system, or may include a one-to-one correspondence relationship between multiple groups of disk numbers and the cloud storage service system.

A second implementation mode of step 102, includes, for example: S21-S22:

S21: Extract, from the traditional file access request, a file path prefix of a file to be accessed.

S22: Determine whether the file path prefix is present in a pre-stored mapping table of the relationship between the file path prefix and the cloud storage service system, and if yes, determine that the traditional file access request is related to accessing the cloud storage service system.

In this implementation mode, mounting processing is performed in advance to mount the file of the cloud storage service system to a particular file folder of the client. In the meantime, a mapping table of the relationship between the file path prefix and the cloud storage service system is set and stored, where the mapping table stores mapping relationship between file folder paths and the cloud storage service system. In some embodiments, one or more files of the cloud storage service system may be mounted to a same or different file folders of the client.

Exemplary implementation process of this mode is described and illustrated by way of a non-limiting example below.

For example, there are two file folders on a local disk of the client: C:\LocalStorage and C:\NetworkStorage. The file of the cloud storage service system may be mounted to the file folder C:\NetworkStorage in advance. When the mounting processing is completed, a mapping table of the relationship between the file path prefix and the cloud storage service system further is set and stored in accordance with, for example:
[C:\NetworkStroage=>oss:\\bucket\folder1].

In this case, the user will see content of the local disk when accessing C:\LocalStorage\xxx, and will see files of the remote cloud storage service system when accessing C:\NetworkStorage\yyy.

When the user accesses C:\NetworkStorage\yyy, it is determined whether a prefix exactly matching the file path prefix is present in the mapping table. If yes, a corresponding location is used to access the cloud storage oss:\\bucket\folder1\yyy; otherwise, no processing is performed.

In addition, step 102 may alternatively be implemented in accordance with a third mode.

The third implementation mode of step 102 includes, for example: S31-S32:

S31: Extract, from the traditional file access request, a disk number of a disk to be accessed.

S32: Determine whether the disk to be accessed is a mounted disk based on the disk number and a pre-stored list of disk numbers of mounted disks, the mounted disk being a disk to which the cloud storage service system is mounted through a file sharing system protocol, and if yes, determine that the traditional file access request is used for accessing the cloud storage service system.

In this mode, mounting processing is performed in advance to mount the file of the cloud storage service system to a disk. For example, the file may be mounted to a local disk or may be mounted to a network disk. An access of the user to the mounted disk is then an access to the cloud storage service system.

In some embodiments, by the mounting processing, one or more files of the cloud storage service system may be mounted to one disk, or different files of the cloud storage service system may be mounted to different disks. In this case, initiation of a traditional file access request to these mounted disks by the user using the client application is converted to the initiation of an access request to the cloud storage service system.

An exemplary implementation process of this mode is described and illustrated by way of a non-limiting example below.

For example, local disks of the client include three disks: Disk C, Disk D, and Disk F. A File 1 of the cloud storage service system may be mounted to Disk C in advance, a File 2 may be mounted to Disk D in advance, and a mapping table of the relationship between the mounted disk number and the cloud storage service system is stored. This allows the user to see content of File 1 of the cloud storage service system when accessing Disk C, to see content of the File 2 of the cloud storage service system when accessing Disk D, and to see local content of Disk F when accessing Disk F.

As described herein, step 102 may be implemented by using an API Hook program, or by using an operating system. When the result of the determination step in step 102 is yes, it indicates that the user intends to access the cloud storage service system. Then, step 103 is executed.

Step 103: Convert the traditional file access request into an access request recognizable by the cloud storage service system and initiate an access to the cloud storage service system.

In some embodiments, step 103 may have several implementation modes, which are described and illustrated in detail below.

A first implementation mode of step 103 includes, for example: S41-S43:

S41: Convert the traditional file access request into a request recognizable by a file sharing system by using a file sharing system client embedded in an operating system, and send the request to a file sharing system server.

S42: Convert the request received by the file sharing system server into an access request recognizable by a client of the cloud storage service system, and send the request to the client of the cloud storage service system.

S43: Convert the access request into an HTTP access request by using the client of the cloud storage service system, and send the HTTP access request to a server of the cloud storage service system.

In some embodiments, the file sharing system may be a Network File System (NFS), a Filesystem in Userspace (FUSE), or Samba. In the present disclosure, NFS, FUSE, and Samba may be understood as examples of a file system driver (FS Driver). In some embodiments, the present disclosure may also be implemented by using other self-defined file drivers.

The NFS allows computers in a network to share resources through a TCP/IP network. An NFS client can transparently read and write a file on a remote NFS server, similar to accessing a local file.

The FUSE (Filesystem in Userspace) is a module for mounting some network spaces to a local file system in Linux.

Samba is a server message block (SMB) protocol implemented on Linux and UNIX systems, and is formed by server and client programs. The SMB (Server Messages Block) is a communication protocol for file and printer sharing in a local area network, which provides services of sharing resources, such as files and printers, for different computers in the local area network.

Although communication protocols of NFS, FUSE, and Samba are different, they similarly implement forwarding of an access request through communication between a client and a server in the embodiments of the present disclosure. In the embodiments of the present disclosure, their working principles are similar.

A second implementation mode of step 103 includes, for example: S51-S52:

S51: Convert the traditional file access request into an access request recognizable by a client of the cloud storage service system, and send the access request to the client of the cloud storage service system.

S52: Convert the access request into an HTTP access request by using the client of the cloud storage service system, and send the HTTP access request to a server of the cloud storage service system.

After step 103 is executed, step 104 is executed.

Step 104: Receive result data returned by the cloud storage service system, convert the result data into a traditional file format, and return the result data to the client application.

In some embodiments, the cloud storage service system may be a distributed storage system or an object storage system. Regardless of the type of the cloud storage service system, the traditional application can achieve access to the cloud storage service system using the embodiment of the present disclosure.

In some embodiments, step 104 feeds back result data to the client application in accordance with a transmitting path of the access request. Therefore, the implementation process of step 104 is related to the request sending process of step 103. Thus step 104 also has two implementation modes corresponding to the two implementation modes of step 103.

A first implementation mode of step 104 includes for example: S61-S62:

S61: Receive, by using the client of the cloud storage service system, result data returned by the server of the cloud storage service system, convert the result data into a format recognizable by the file sharing system, and send the result data to the file sharing system server.

S62: Send processing results to the file sharing system client by using the file sharing system server, convert the processing result into a traditional file format by using the file sharing system client, and send the processing result to the client application.

A second implementation mode of step 104 includes, for example: S71-S72:

S71: Receive, by using the client of the cloud storage service system, result data returned by the server of the cloud storage service system, and convert the result data into a traditional file format.

S72: Send the result data of the traditional file format to the client application by using an API Hook program. In some embodiments, the file sharing system client, the file sharing system server, the client of the cloud storage service system, and the server of the cloud storage service system that are described above may be in the form of a computer program.

In accordance with the technical solution provided by the present disclosure, when no modification is made to traditional software, the traditional software initiates a traditional file access request by using an interface provided by a traditional operating system, and the traditional file access request is acquired first by using the API HOOK technology or the FS Driver technology; then, it is determined whether a disk to be accessed is associated with a cloud storage service system; if yes, it determines that the traditional file access request is used for accessing the cloud storage service system. In this case, the format of the traditional file access request is converted into an access request recognizable by the cloud storage service system, thereby implementing the access to the cloud storage service system. In this way, the running logic of the traditional software is changed by converting the format of the access request without changing the interface of the traditional software to allow the cloud storage service system responds to the request, thereby providing a convenient method for the traditional software to access the cloud storage service system.

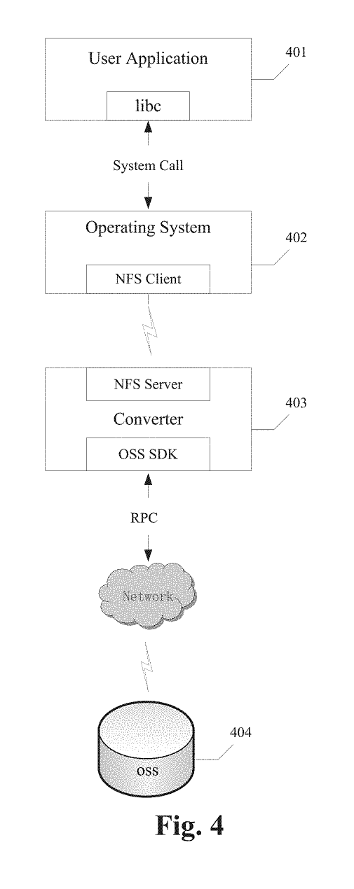

An exemplary method provided by the present disclosure are described below with reference to FIG. 4.

FIG. 4 is a schematic diagram illustrating an exemplary method for accessing a cloud storage service based on a traditional file system interface, consistent with embodiments of the present disclosure.

FIG. 4 illustrates an exemplary application scenario where a client implements, through interaction between an NFS and an Object Storage Service (OSS) object storage system, the access of a traditional application to the OSS based on a traditional file system interface. The application scenario shown in FIG. 4 is as follows:

As shown in FIG. 4, user application 401 is a traditional application of a client. Operating system 402 (OS for short) is an operating system of the client, an NFS client being installed in the operating system. Converter 403 performs functions of converting and forwarding an access request, and includes an NFS Server and an OSS SDK (OSS client). OSS 404 (object storage service) may be understood as an OSS server. The OSS SDK accesses the OSS by using RPC.

FIG. 4 is exemplary only. In some embodiments, the NFS Server and the OSS SDK may be processes of the client that work in a same device as the application, or may be a group of independent front-end servers.

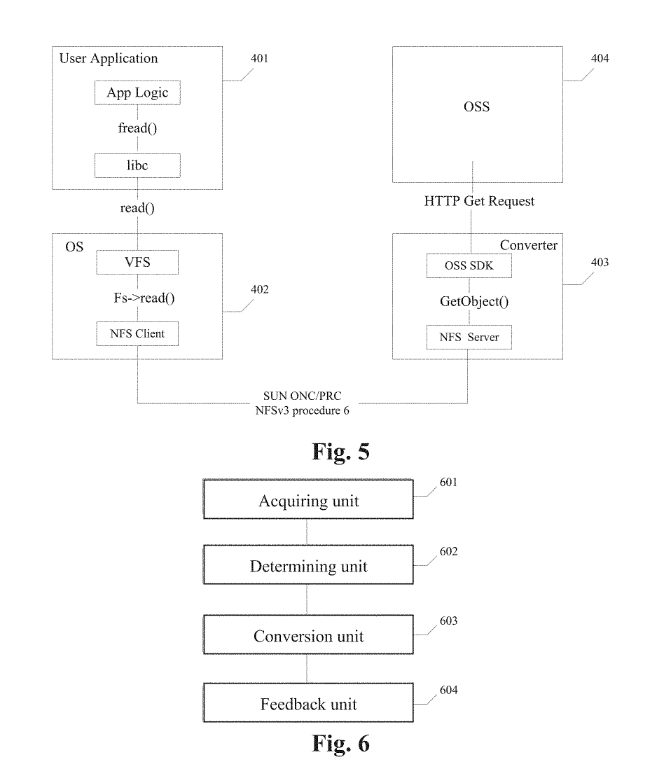

Next, for the scenario shown in FIG. 4, an exemplary implementation process of the above-described method for accessing a cloud storage service based on a traditional file system interface is described with reference to FIG. 5. As shown in FIG. 5, user application 401, OS 402, OSS 404 are existing components. In some embodiments, converter 403 is additionally provided. In OS 402, VFS is a Virtual File System, and is also referred to as a Virtual File System Switch, which is an interface of a Linux file system to the outside. A program that needs to use the file system would be through the interface of this layer.

When a user initiates a file read request by using user application 401, a read method provided by libc is usually used. This method is a package of a file access interface of the operating system by the libc. The libc converts this method into a system call and submits the system call to the OS. That is, when the client application sends a traditional file access request, it will be trapped into the kernel mode via a system call. In this case, the operating system will find the traditional file access request, and thus acquire the traditional file access request.

The file read request may be a request for reading a mounted disk. The mounted disk is mounted in advance by using the NFS protocol. In this case, the OS finds the file request, and calls the corresponding read method of the corresponding file system, so as to provide services. Because the disk to be accessed is mounted using the NFS protocol, this request will be converted into an NFS read RPC call, and transmitted to converter 403 through a network. An NFS server is configured in converter 403, and after receiving an NFS No. 6 procedure call (e.g., file read) from the NFS client, checks corresponding parameters, for example, whether the read location and the read length are valid. For example, if it is found that the read location is already beyond the ending of the file, an error is directly returned, and no request will be initiated to the cloud storage service system. If the check is valid, the request is converted into an OSS object read request, sent to the OSS SDK, and sent out through the GetObject( ) method provided by the OSS SDK. The OSS SDK will convert this request into an HTTP GET method and finally send the HTTP GET method to an OSS service cluster.

The OSS service cluster feeds back result data to the OSS SDK, and the OSS SDK converts the result data into a format recognizable by the NFS, and sends the result data of the format to the NFS Server. The NFS Server feeds back a processing result to the NFS client through a network, and the NFS client converts the processing result into a format recognizable by user application 401, and sends the processing result of the format to the User Application.

FIG. 5 merely describes using a file read access request as an example. If the user initiates a file write access request by using an application, the processing procedure is similar to that shown in FIG. 5, except that a write-related function needs to be called.

It is appreciated that the basic idea of the method provided by the present disclosure is to execute a mount command in a framework supported by an operating system to mount a file stored in a cloud storage service system to a local disk of a client. Logic of the application does not need to be modified, but instead, an NFS is used to take control over a traditional file access request from the application, convert it into a request recognizable by a cloud storage service system, and finally execute the request. As shown in FIGS. 4 and 5, taking control over the traditional file access request from the application is achieved by using the NFS. In other embodiments, FUSE, Samba, and the API HOOK technology described above may also be used for implementation of the exemplary method described in reference to FIGS. 4 and 5.

The present disclosure also provides an exemplary apparatus for accessing a cloud storage service based on a traditional file system interface. The exemplary apparatus may be used to implement the method described above.

The structure and working principles of the apparatus are described and illustrated below with reference to FIG. 6.

FIG. 6 is a schematic block diagram illustrating an exemplary apparatus for accessing a cloud storage service based on a traditional file system interface, consistent with embodiments of the present disclosure. As shown in FIG. 6, the apparatus may include: an acquiring unit 601, a determining unit 602, a conversion unit 603, and a feedback unit 604. It is appreciated that each of these units (and any corresponding sub-units) can be packaged functional hardware unit designed for use with other components (e.g., portions of an integrated circuit) or a part of a program (stored on a computer readable medium) that performs a particular function of related functions.

The acquiring unit 601 is configured to acquire a traditional file access request sent by a client application.

The determining unit 602 is configured to determine whether the traditional file access request is related to a cloud storage service system based on pre-stored file or disk information related to the cloud storage service system; and if yes, execute the conversion unit 603;

The conversion unit 603 is configured to convert the traditional file access request into an access request recognizable by the cloud storage service system, and initiate an access to the cloud storage service system.

The feedback unit 604 is configured to receive result data returned by the cloud storage service system, convert the result data into a traditional file format, and return the result data to the client application.

In some embodiments, the acquiring unit 601 may be configured to acquire, by using an API HOOK program, the traditional file access request sent by the client application; or acquire, by using an operating system, the traditional file access request sent by the client application.

In some embodiments, the determining unit 602 includes: a first extraction subunit configured to extract, from the traditional file access request, a disk number of a disk to be accessed; and a first determining subunit, configured to determine whether the disk number is present in a pre-stored mapping table of the relationship between disk numbers and the cloud storage service system, and if yes, it determines that the traditional file access request is related to the cloud storage service system.

In some embodiments, the determining unit 602 includes: a second extraction subunit configured to extract, from the traditional file access request, a file path prefix of a file to be accessed; and a second determining subunit configured to determine whether the file path prefix is present in a pre-stored mapping table of the relationship between the file path prefix and the cloud storage service system, and if yes, it determines that the traditional file access request is related to the cloud storage service system.

In some embodiments, the determining unit 602 includes: a third extraction subunit configured to extract, from the traditional file access request, a disk number of a disk to be accessed; and a third determining subunit configured to determine whether the disk number is present in a pre-stored association mapping relationship table of mounted disk numbers and the cloud storage service system, the mounted disk number being a number indicating a disk to which a file of the cloud storage service system is mounted, and if yes, it determines that the traditional file access request is related to the cloud storage service system.

In some embodiments, the conversion unit 603 includes: a first conversion subunit configured to convert the traditional file access request into a request recognizable by a file sharing system by using a file sharing system client embedded in an operating system, and send the request to a file sharing system server; a second conversion subunit configured to convert the request received by the file sharing system server into an access request recognizable by a client of the cloud storage service system, and send the access request to the client of the cloud storage service system; and a third conversion subunit configured to convert the access request into an HTTP access request by using the client of the cloud storage service system, and send the HTTP access request to a server of the cloud storage service system.

In some embodiments, the conversion unit includes: a fourth conversion subunit configured to convert the traditional file access request into an access request recognizable by a client of the cloud storage service system, and send the access request to the client of the cloud storage service system; and a fifth conversion subunit configured to convert the access request into an HTTP access request by using the client of the cloud storage service system, and send the HTTP access request to a server of the cloud storage service system.

In some embodiments, the file sharing system is an NFS, a FUSE, or Samba.

In some embodiments, the cloud storage service system is a distributed file system or object storage system that supports a cloud storage service.

It is appreciated that consistent with the embodiments of the present disclosure, when no modification is made to traditional software and the traditional software initiates a traditional file access request by using an interface provided by a traditional operating system, and the traditional file access request is acquired first by using the API HOOK technology or the FS Driver technology; then, it is determined whether a disk to be accessed is associated with a cloud storage service system; if yes, it determines that the traditional file access request is used for accessing the cloud storage service system. In this case, the format of the traditional file access request is converted into an access request recognizable by the cloud storage service system, thereby implementing the access to the cloud storage service system. In this way, the running logic of the traditional software is changed by converting the format of the access request without changing the interface of the traditional software to allow the cloud storage service system responds to the request, thereby providing a convenient method for the traditional software to access the cloud storage service system.

The present disclosure may be described in a general context of computer-executable commands or operations, such as a program module, stored on a computer readable medium and executed by a computing device or a computing system, including at least one of a microprocessor, a processor, a central processing unit (CPU), a graphical processing unit (GPU), etc. In general, the program module may include routines, procedures, objects, components, data structures, processors, memories, and the like for performing specific tasks or implementing a sequence of steps or operations.

The present disclosure may also be implemented in a distributed computing environment, and in these distributed computing environments, tasks or operations may be executed by a remote processing device connected through a communication network, e.g., the Internet. In the distributed computing environment, the program module may be located in a local or a remote non-transitory computer-readable storage medium, including a flash disk or other forms of flash memory, a Read-Only Memory (ROM), a Random Access Memory (RAM), a magnetic disk, an optical disk, a cache, a register, etc.

Furthermore, although aspects of the disclosed embodiments are described as being associated with data and/or instructions stored in a memory and/or other tangible and/or non-transitory computer-readable mediums, it would be appreciated that these data and/or instructions can also be stored on and executed from many types of tangible computer-readable storage medium, such as storage devices, including hard disks, floppy disks, or CD-ROM, or other forms of RAM or ROM. Accordingly, the disclosed embodiments are not limited to the above-described examples, but instead is defined by the appended claims in light of their full scope of equivalents.

Embodiments of the present disclosure may be embodied as a method, a system, a computer program product, etc. Accordingly, embodiments of the present disclosure may take the form of an entirely hardware embodiment, an entirely software embodiment, or an embodiment combining software and hardware for allowing a specialized device having the described specialized components to perform the functions described above. Furthermore, embodiments of the present disclosure may take the form of a computer program product embodied in one or more computer-readable storage media that may be used for storing computer-readable program codes.

Embodiments of the present disclosure are described with reference to flow charts and/or block diagrams of methods, devices (systems), and computer program products. It will be understood that each flow chart and/or block diagram can be implemented by computer program instructions. These computer program instructions may be provided to a processor of a special-purpose computer, an embedded processor, or other programmable data processing devices or systems to produce a machine or a platform, such that the instructions, when executed via the processor of the computer or other programmable data processing devices, implement the functions and/or steps specified in one or more flow charts and/or one or more block diagrams.

The computer-readable storage medium may refer to any type of non-transitory memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, removable and non-removable media. The information and/or data storage can be implemented with any method or technology. Information and/or data may be modules of computer-readable instructions, data structures, and programs, or other types of data. Examples of a computer-readable storage medium include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a cache, a register, a compact disc read-only memory (CD-ROM), a digital versatile disc (DVD) or other optical storage, a cassette tape, tape or disk storage, or other magnetic storage devices, or any other non-transitory media that may be used to store information capable of being accessed by a computer device.

It should be noted that, the relational terms such as “first” and “second” are only used to distinguish an entity or operation from another entity or operation, and do necessarily require or imply that any such actual relationship or order exists among these entities or operations. It should be further noted that, as used in this specification and the appended claims, the singular forms “a,” “an,” and “the,” and any singular use of any word, include plural referents unless expressly and unequivocally limited to one referent. As used herein, the terms “include,” “comprise,” and their grammatical variants are intended to be non-limiting, such that recitation of items in a list is not to the exclusion of other like items that can be substituted or added to the listed items.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps. It is intended, therefore, that the specification and examples be considered as example only, with a true scope and spirit being indicated by the following claims and their full scope of equivalents.

This description and the accompanying drawings that illustrate exemplary embodiments should not be taken as limiting. Various mechanical, compositional, structural, electrical, and operational changes may be made without departing from the scope of this description and the claims, including equivalents. In some instances, well-known structures and techniques have not been shown or described in detail so as not to obscure the disclosure. Similar reference numbers in two or more figures represent the same or similar elements. Furthermore, elements and their associated features that are disclosed in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A method for accessing a cloud storage service by using a conventional file system interface, the method comprising:
acquiring a traditional file access request sent by a client application;
determining whether the traditional file access request is related to a cloud storage service system based on pre-stored file or disk information related to the cloud storage service system;
responsive to determining that the traditional file access request is related to a cloud storage service system, converting the traditional file access request into an access request recognizable by the cloud storage service system and initiating an access to the cloud storage service system; and
receiving result data returned by the cloud storage service system, converting the result data into a traditional file format, and returning the result data to the client application.

2. The method of claim 1, wherein acquiring a traditional file access request sent by a client application further comprises:
acquiring, by using an API HOOK program, the traditional file access request sent by the client application; or
acquiring, by using an operating system, the traditional file access request sent by the client application.

3. The method of claim 1, wherein determining whether the traditional file access request is related to a cloud storage service system based on pre-stored file or disk information related to the cloud storage service system further comprises:
extracting, from the traditional file access request, a disk number of a disk to be accessed; and
determining whether the disk number is present in a pre-stored mapping table of the relationship between disk numbers and the cloud storage service system, and
responsive to determining that the disk number is present in the pre-stored mapping table, determining that the traditional file access request is related to the cloud storage service system.

4. The method of claim 1, wherein determining whether the traditional file access request is related to a cloud storage service system based on pre-stored file or disk information related to the cloud storage service system further comprises:
extracting, from the traditional file access request, a file path prefix of a file to be accessed; and
determining whether the file path prefix is present in a pre-stored mapping table of the relationship between file path prefixes and the cloud storage service system, and
responsive to determining that the file path prefix is present in the pre-stored mapping table, determining that the traditional file access request is related to the cloud storage service system.

5. The method of claim 1, wherein determining whether the traditional file access request is related to a cloud storage service system based on pre-stored file or disk information related to the cloud storage service system further comprises:
extracting, from the traditional file access request, a disk number of a disk to be accessed; and
determining whether the disk number is present in a pre-stored mapping table of the relationship between mounted disk numbers and the cloud storage service system, a mounted disk number being a number indicating a disk to which a file of the cloud storage service system is mounted, and
responsive to determining that the disk number is present in the pre-stored mapping table, determining that the traditional file access request is related to the cloud storage service system.

6. The method of claim 1, wherein converting the traditional file access request into an access request recognizable by the cloud storage service system, and initiating an access to the cloud storage service system further comprises:
converting the traditional file access request into a request recognizable by a file sharing system by using a file sharing system client embedded in an operating system, and sending the request to a file sharing system server;
converting the request received by the file sharing system server into an access request recognizable by a client of the cloud storage service system, and sending the access request to the client of the cloud storage service system; and
converting the access request into an HTTP access request by using the client of the cloud storage service system, and sending the HTTP access request to a server of the cloud storage service system.

7. The method of claim 6, wherein the file sharing system is a Network File System (NFS), a Filesystem in Userspace (FUSE), or Samba.

8. The method of claim 1, wherein converting the traditional file access request into an access request recognizable by the cloud storage service system, and initiating an access to the cloud storage service system further comprises:
converting the traditional file access request into an access request recognizable by a client of the cloud storage service system, and sending the access request to the client of the cloud storage service system; and
converting the access request into an HTTP access request by using the client of the cloud storage service system, and sending the HTTP access request to a server of the cloud storage service system.

9. The method of claim 1, wherein the cloud storage service system is a distributed file system or object storage system that supports the cloud storage service.

10. An apparatus for accessing a cloud storage service based on a traditional file system interface, the apparatus comprising:
an acquiring unit used for acquiring a traditional file access request sent by a client application;
a determining unit used for determining whether the traditional file access request is related to a cloud storage service system based on pre-stored file or disk information related to the cloud storage service system; and responsive to determining that the traditional file access request is related to a cloud storage service system, execute a conversion unit;
the conversion unit used for converting the traditional file access request into an access request recognizable by the cloud storage service system and initiate an access to the cloud storage service system; and
a feedback unit used for receiving result data returned by the cloud storage service system, converts the result data into a traditional file format, and return the result data to the client application.

11. The apparatus of claim 10, wherein the acquiring unit is further used for:
acquiring, by using an API HOOK program, the traditional file access request sent by the client application; or
acquiring, by using an operating system, the traditional file access request sent by the client application.

12. The apparatus of claim 10, wherein the determining unit comprises:
a first extraction subunit used for extracting, from the traditional file access request, a disk number of a disk to be accessed; and
a first determining subunit used for determining whether the disk number is present in a pre-stored mapping table of the relationship between disk numbers and the cloud storage service system, and responsive to determining that the disk number is present in the pre-stored mapping table, determine that the traditional file access request is related to the cloud storage service system.

13. The apparatus of claim 10, wherein the determining unit comprises:
a second extraction subunit used for extracting, from the traditional file access request, a file path prefix of a file to be accessed; and
a second determining subunit used for determining whether the file path prefix is present in a pre-stored mapping table of the relationship between file path prefixes and the cloud storage service system, and responsive to determining that the file path prefix is present in the pre-stored mapping table, determine that the traditional file access request is related to the cloud storage service system.

14. The apparatus of claim 10, wherein the determining unit comprises:
a third extraction subunit used for extracting, from the traditional file access request, a disk number of a disk to be accessed; and
a third determining subunit used for determining whether the disk number is present in a pre-stored mapping table of the relationship between mounted disk numbers and the cloud storage service system, a mounted disk number being a number indicating a disk to which a file of the cloud storage service system is mounted, and responsive to determining that the disk number is present in the pre-stored mapping table, determine that the traditional file access request is related to the cloud storage service system.

15. The apparatus of claim 10, wherein the conversion unit comprises:
a first conversion subunit used for converting the traditional file access request into a request recognizable by a file sharing system by using a file sharing system client embedded in an operating system, and send the request to a file sharing system server;
a second conversion subunit used for converting the request received by the file sharing system server into an access request recognizable by a client of the cloud storage service system, and send the access request to the client of the cloud storage service system; and
a third conversion subunit used for converting the access request into an HTTP access request by using the client of the cloud storage service system, and send the HTTP access request to a server of the cloud storage service system.

16. The apparatus of claim 10, wherein the conversion unit comprises:
a fourth conversion subunit used for converting the traditional file access request into an access request recognizable by a client of the cloud storage service system, and send the access request to the client of the cloud storage service system; and
a fifth conversion subunit used for converting the access request into an HTTP access request by using the client of the cloud storage service system, and send the HTTP access request to a server of the cloud storage service system.

17. A non-transitory computer readable medium that stores a set of instructions that is executable by at least one processor of a server to cause the server to perform a method for accessing a cloud storage service based on a traditional file system interface, the method comprising:
acquiring a traditional file access request sent by a client application;
determining whether the traditional file access request is related to a cloud storage service system based on pre-stored file or disk information related to the cloud storage service system;
responsive to determining that the traditional file access request is related to a cloud storage service, converting the traditional file access request into an access request recognizable by the cloud storage service system and initiating an access to the cloud storage service system; and
receiving result data returned by the cloud storage service system, converting the result data into a traditional file format, and returning the result data to the client application.

18. The medium of claim 17, wherein acquiring a traditional file access request sent by a client application further comprises:
acquiring, by using an API HOOK program, the traditional file access request sent by the client application; or
acquiring, by using an operating system, the traditional file access request sent by the client application.

19. The medium of claim 17, wherein converting the traditional file access request into an access request recognizable by the cloud storage service system, and initiating an access to the cloud storage service system further comprises:
converting the traditional file access request into a request recognizable by a file sharing system by using a file sharing system client embedded in an operating system, and sending the request to a file sharing system server;
converting the request received by the file sharing system server into an access request recognizable by a client of the cloud storage service system, and sending the access request to the client of the cloud storage service system; and
converting the access request into an HTTP access request by using the client of the cloud storage service system, and sending the HTTP access request to a server of the cloud storage service system.

20. The medium of claim 17, wherein converting the traditional file access request into an access request recognizable by the cloud storage service system, and initiating an access to the cloud storage service system further comprises:
converting the traditional file access request into an access request recognizable by a client of the cloud storage service system, and sending the access request to the client of the cloud storage service system; and
converting the access request into an HTTP access request by using the client of the cloud storage service system, and sending the HTTP access request to a server of the cloud storage service system.
